(19) United States
(12) Patent Application Publication
(10) Pub. No.: US 2020/0173688 A1
(43) Pub. Date: Jun. 4, 2020

(54) ELECTRIC HEATING DEVICE, METHOD FOR PRODUCING, OPERATING AND USING SAID TYPE OF DEVICE

(71) Applicant: WEBASTO SE, Stockdorf (DE)

(72) Inventors: Martin ZOSKE, Stockdorf (DE); Bengt MEIER, Stockdorf (DE); Christoph JÖRG, Stockdorf (DE); Harald BACHMANN, Stockdorf (DE); Peter NEIDENBERGER, Stockdorf (DE)

(73) Assignee: Webasto SE, Stockdorf (DE)

(21) Appl. No.: 16/615,729

(22) PCT Filed: May 23, 2018
(86) PCT No.: PCT/EP2018/063500

§ 371 Date: Nov. 21, 2019

(30) Foreign Application Priority Data
May 24, 2017 (DE) 10 2017 111 373.8
May 24, 2017 (DE) 10 2017 111 378.9
Jul. 6, 2017 (DE) 10 2017 115 148.6
Sep. 12, 2017 (DE) 10 2017 121 060.1

(51) Int. Cl. F24H 3/04; F24H 1/12; F24H 1/10; H05B 3/14

(52) U.S. Cl. CPC F24H 3/0429; F24H 1/121; F24H 1/103; H05B 2203/021; F24H 2250/04; H05B 2203/02; H05B 2203/023; H05B 3/146

(57) ABSTRACT

An electric heating appliance, particularly a liquid or air heating appliance, particularly for a motor vehicle, comprising a first heating element with a corresponding main body and at least one second heating element with a corresponding main body. A clearance is formed between the heating elements through which fluid can flow for its heating. The heating elements are joined together by at least one spacer arranged between them, particularly a conductive spacer. The spacer is a fixed component of the first heating element.

### CROSS-REFERENCE TO RELATED APPLICATIONS

This application represents the national stage entry of PCT International Patent Application No. PCT/EP2018/063500 filed on May 24, 2018 and claims priority to German Patent Application No. DE 10 2017 111 373.8 filed May 24, 2017, German Patent Application No. DE 10 2017 111 378.9 filed May 24, 2017, German Patent Application No. DE 10 2017 115 148.6 filed Jul. 6, 2017, and German Patent Application No. DE 10 2017 121 060.1 filed Sep. 12, 2017. The contents of each of these applications are hereby incorporated by reference as if set forth in their entirety herein.

### DESCRIPTION

The disclosure relates to an electric heating appliance, particularly for a motor vehicle, a method for producing an electric heating appliance, a method for operating a heating appliance and a use of a heating appliance.

From EP 1 912 028 A1 it is known how to stack several (electric) heating elements of a heating assembly, wherein the heating elements are spaced apart from each other by additional spacers and the individual heating elements are strung on corresponding tie rods. The spacers should particularly preferably be made from the same material as the tie rods. On the whole, the design of EP 1 912 028 A1 is felt to be expensive.

The problem which the disclosure proposes to solve is to propose a heating appliance, particularly a liquid and/or air heating appliance, preferably for a vehicle, particularly a motor vehicle, which is relatively simple to produce and which also enables in particular an effective heating of the fluid. Furthermore, one problem of the disclosure is to propose a corresponding method for producing a heating appliance, particularly a liquid and/or air heating appliance, a corresponding method for operating a heating appliance, particularly a liquid and/or air heating appliance, and a corresponding use of a heating appliance.

This problem is solved in particular by an electric heating appliance according to claim 1.

In particular, the problem is solved by an electric heating appliance, preferably a fluid heating appliance, particularly a liquid or air heating appliance, preferably for a vehicle, more preferably for a motor vehicle, particularly for a passenger car and/or a lorry (and/or for a ship and/or an aircraft), comprising a first (electrical) heating element with a corresponding main body and at least one second (electrical) heating element with a corresponding main body, wherein a clearance is formed between the (electrical) heating elements through which fluid (i.e., a liquid and/or a gas, such as air) can flow for its heating, wherein the heating elements are joined together by at least one spacer arranged between them, particularly an (electrically) conductive spacer, wherein the spacer is a fixed component of the first heating element.

A key notion of the disclosure is to provide at least one spacer making possible a stacking of multiple heating elements in simple manner, wherein this spacer is not designed as a separate part (as in EP 1 912 028 A1), but rather is formed as a fixed component of one of the heating elements (specifically, the first heating element, which does not rule out that another heating element is also assigned a corresponding spacer). In this way, an efficiently operating (electrical) heating appliance can be realized with a relatively simple production.

Basically, the heating element may comprise exactly one or more than one spacer as its fixed component. The second heating element may comprise (exactly) one or more spacers, which can be designed and constructed exactly the same as described in regard to the spacer or spacers of the first heating element. Furthermore, a third, fourth or even further heating element may also be provided. These further heating elements may optionally also have spacers, which are designed and constructed as described in connection with the one or more spacer(s) of the first heating element. Accordingly, as the one or more spacers of the first heating element are described and defined in the following with further details, the corresponding features also apply (optionally) to optionally provided spacers in particular as fixed components of the further heating elements (respectively in regard to one of the further heating elements, several of the further heating elements or all of the further heating elements and/or in regard to a single heating element or to several or all of the heating elements, each time in regard to (the) one spacer, several spacers—if so provided—or all the spacers). In particular, this applies to the structural configuration, arrangement, orientation and/or number of the respective spacers.

The (respective) main body of the (respective) heating element is a section of the (respective) heating element which is bounded off, particularly structurally, by one or more possibly provided spacer(s). Insofar as no spacer is provided as a fixed component (for example, for a second or further heating element), the corresponding main body may also define the entire heating element. Preferably, the main body of the respective heating element forms at least 50% (by weight), further preferably at least 80% (or possibly 100%, for example when no corresponding spacer is provided) of the corresponding heating element. According to the embodiment, the main body may be a plate-shaped body (a plate). The respective plate is preferably at least substantially flat (fluctuations in the thickness, if any, are in particular such that a maximum thickness is not greater than a minimum thickness plus 20% of the minimum thickness). The (respective) spacer preferably stands out from a principal plane at an angle which is defined by the main body. Specifically, the spacer may for example extend at an angle of at least 30°, preferably at least 60°, optionally at least approximately 90° with respect to this principal plane (at least for the major portion, i.e., more than 50% of its overall extension, which may also optionally be curved).

By a “fixed” component of the first heating element is meant in particular a component which is connected to the corresponding main body in such a way that it is also not detached from or only lies loosely against the heating element when the heating element is present separately. Thus, for example, the spacer is held not only due to the fact that the electric heating appliance in the assembled state comprises multiple heating elements which in turn hold the spacer between them. Such a spacer in particular will not be understood as being a fixed component of the first (or any other) heating element.

Preferably the spacer is connected undetachably to the main body of the first heating element. By an undetachable connection is meant in particular a connection which cannot be loosened without being destroyed (i.e., by destroying the structure of the heating element) or one in which a breaking off of the (fixed) connection cannot be restored again (without new, additional fastening means).

The spacer may be connected by material bonding, force locking and/or form fitting to the main body of the first heating element. The materially bonded connection occurs preferably by welding, particularly laser welding. But a gluing is also possible (alternatively or additionally).

The spacer is particularly preferably formed as an integral, particularly a monolithic component of the first heating element. By an integral component is meant in particular a component for which no (distinct) material boundary exists between spacer and main body. Thus, a transition from main body to spacer occurs in particular continuously. By a monolithic component is meant in particular a component for which the heating element as a whole is present as a unified block. Preferably the spacer (at least for a portion) and the main body (at least for a portion) are made from the same material. If spacer and/or main body are made from several materials, this holds preferably for at least one of the respective materials, possibly for several or all of the materials. If the heating element comprises for example a substrate and an (electric) heating structure (e.g., a heating layer), the spacer can be made at least from the same material as the substrate of the heating element, possibly also additionally comprising a corresponding heating structure (which is then preferably of the same material), such as a heating layer.

In specific embodiments, a material of the spacer from which the spacer is formed for at least 50 wt. % can be a material from which the main body is formed for at least 50%, preferably 80%.

The (respective) spacer(s) of a heating element may make up (in terms of weight) less than 20%, preferably less than 10% of the total weight of the heating element. If several spacers are provided, this may hold for each individual spacer and/or for all spacers in their entirety.

The respective heating element (optionally several or all of the heating elements) may comprise a polymer structure, containing a polymer component and a conductive component, particularly a carbon component. In particular embodiments, the respective heating element (or all the heating elements) can comprise in each case a substrate, particularly an insulating one, and/or a polymer layer as the polymer structure. Such a heating appliance is particularly easy to manufacture and effective in operation.

The first and/or second (electrical) heating element may be electrically contacted across the one (or more) spacers, optionally solely across the spacer(s). In this way, a relatively simple construction can be provided, which simplifies the manufacture and operation.

The spacer may be formed from the respective (particularly the first) heating element by cutting (or at least partial separating) and/or stamping and/or bending. In general, the spacer is preferably formed from the particular (e.g., the first) heating element in such a way that a connection with the other portions of the heating element (i.e., particularly with the main body) is not interrupted (also in particular not even for a portion) (at least not entirely, which is possible in the case of cutting and/or stamping). This simplifies the manufacturing process and enables an effective operation.

Preferably the (respective) spacer is in (direct) electrical and/or mechanical contact with a carrier and/or bridge element which electrically and/or mechanically connects the first and the second heating element. By a carrier element is meant in particular an element which at least partly (or entirely) carries the first and/or second heating element, i.e., in particular holds it (possibly in concert with at least one or precisely one further carrier element). By a bridge element is meant in particular an element which electrically (possibly also mechanically) bridges or connects the first and second heating element. Carrier and/or bridge element may also be in electrical and/or mechanical (direct) contact with other components of the heating element (i.e., not just with the spacer). A connection between spacer on the one hand and carrier and/or bridge element on the other hand is provided preferably by force locking and/or material bonding, for example, by press-fitting and/or soldering and/or welding, particularly laser welding. On the whole, the spacer may have a dual function, which further simplifies the manufacturing.

In embodiments, the respective (i.e., the first) heating element may comprise at least one opening for receiving a carrier element, particularly a rod-shaped one, preferably a conductive one, wherein the at least one spacer is preferably arranged at least partly around the opening (particularly in a ring shape).

In general, the spacer may be rod-shaped (e.g., a solid cylinder, with possibly circular diameter) or ring-shaped (e.g., a hollow cylinder, with possibly circular diameter) or strip- or moulding-shaped. In a strip or moulding configuration, a width of the spacer is preferably at least twice, preferably at least 5 times as large as a spacing between the heating elements between which the spacer is arranged. The spacer for example may extend over the entire length of one side of the first and/or second heating element (or only over a portion thereof).

In further embodiments, the spacer is formed at a (side) edge (possibly the entire edge) of the first heating element, preferably by a rolling and/or crimping (or flanging). By a crimping is meant in particular a bending over of one edge of the (respective) heating element (e.g., with a crimping machine or by hand). By a rolling is meant a rolling in or a rolling bending of the heating element (at its edge). The respective “edge” may be an outer edge (at which the heating element terminates) or an inner edge, defining for example an (inner) opening or recess.

The first and/or second heating element may extend at least substantially along a fluid flow direction. Alternatively, the first and/or second heating element may extend at a (given) angle with respect to the fluid flow direction, e.g., at an angle of ≤90° and >0°, particularly ≥10°.

The respective polymer structure, particularly the polymer layer, may be applied by imprinting (particularly onto the substrate) (e.g., by silk screening) or by some other coating method (such as doctoring). The (respective) heating element may also comprise multiple films made from a (corresponding) polymer structure and/or be produced (at least partly) by lamination and/or (at least partly) by extrusion. Alternatively or additionally, electrical terminal structures (electrodes) may be imprinted onto the substrate or the polymer layer or be applied by some other coating method. Optionally, a curing step at elevated temperature (such as over 120° C.) may be done in an oven.

The conductive component, particularly a carbon component, may be present in particulate form and/or as a skeleton, particularly a carbon skeleton. The carbon component may be present in the form of carbon black and/or graphite and/or graphene and/or carbon fibres and/or carbon nanotubules.

In embodiments, the polymer component may comprise a first polymer subcomponent based on ethylene acetate (copolymer) and/or ethylene acrylate (copolymer) and/or comprise a second polymer subcomponent based on polyolefin, particularly polyethylene and/or polypropylene, and/or polyester and/or polyamide and/or fluoropolymer. The term “subcomponent” should be used here in particular to distinguish between first and second polymer subcomponent. The respective subcomponent may form the polymer component either partially or entirely. In the case of ethylene acrylate, it may be ethyl-methyl-acrylate or ethylene-ethyl-acrylate. In the case of ethylene acetate, it may be ethylene vinyl acetate. In the case of polyethylene, it may be HD (high density) polyethylene, MD (medium density) polyethylene, LD (low density) polyethylene. In the case of fluoropolymer, it may be PFA (copolymer of tetrafluorethylene and perfluoropropyl vinyl ester) MFA (copolymer of tetrafluorethylene and perfluorovinyl ester), FEP (copolymer of tetrafluorethylene and hexafluorpropylene), ETFE (copolymer of ethylene and tetrafluorethylene) or PVDF (polyvinylidene-fluoride).

The heating appliance preferably comprises at least three or at least four or at least five or at least eight heating elements (with corresponding clearances and optional spacers).

Several (optionally all) heating elements may be switched together electrically in parallel in embodiments. Alternatively or additionally, several (optionally all) heating elements may be switched together electrically in series in embodiments.

The above problem is furthermore solved by a method for producing an electric heating appliance, preferably a liquid or air heating appliance, particularly of the kind described above, comprising a first heating element with a corresponding main body and at least one second heating element with a corresponding main body, wherein a clearance is formed between the heating elements through which fluid can flow (particularly a liquid or a gas, particularly air) for its heating, wherein at least one spacer is formed as a fixed component of the first heating element such that the spacer separates the first and the second heating element from each other.

The spacer, while preferably being a fixed component of a particular (e.g., the first) heating element, is not a fixed component of another heating element. Preferably, therefore, the (particular) spacer is not in contact with all the heating elements (except the one, such as the first heating element), or only loosely in contact with them. By a loose contact is meant in particular a contact in which the spacer can be detached or removed from the corresponding heating element with no (significant) expenditure of force, if no other holding or connecting structures (such as bridge elements) are provided (or are at least removed in theory). In particular, therefore, the spacer is not an integral component of another heating element and/or connected by material bonding to another heating element (other than the one for which the respective spacer is a fixed component).

The spacer may be connected undetachably to the main body of the first heating element and/or it is connected by material bonding, force locking and/or form fitting to the main body of the first heating element or it is formed as an integral, particularly a monolithically moulded-on component of the first heating element.

The heating elements may each comprise a polymer structure, containing a polymer component and a conductive component, particularly a carbon component. Preferably, the heating elements (each) comprise a substrate, particularly an insulating one, and/or a polymer layer as the polymer structure.

The spacer is preferably formed from the first heating element by cutting and/or stamping and/or bending.

The spacer is preferably brought into (direct) electrical and/or mechanical contact with a carrier and/or bridge element which electrically and/or mechanically connects the first and the second heating element, wherein a connection between spacer and carrier and/or bridge element is provided preferably by force locking and/or material bonding, for example by press-fitting and/or soldering and/or welding, particularly laser welding.

Preferably the spacer is formed at an edge of the first heating element, particularly by a rolling and/or flanging.

The aforementioned problem is furthermore solved by a method for operating the above heating appliance or one produced according to the above method, wherein fluid, particularly air, or a liquid, such as water, flows through the at least one clearance and is thereby heated.

The aforementioned problem is furthermore solved by the use of a heating appliance of the above kind or one produced according to a method of the above kind, for the heating of fluid, particularly air, or a liquid, such as water, particularly in a motor vehicle, preferably for a motor vehicle interior.

The aforementioned problem is furthermore solved by a vehicle, particularly a motor vehicle, preferably a passenger car or a lorry (alternatively a ship or aircraft, such as an airplane), comprising a heating appliance of the above kind or a heating appliance which has been produced by the above method.

The (respective) spacer may optionally assure both the power supply and guarantee a spacing between the heating elements. Accordingly, the spacer may have a dual function, which on the whole enables a simple construction of the electric heating appliance.

For protection against mechanical damage, moisture, and/or short circuiting, an enamelling or sealing may be present for the polymer structure, particularly the polymer layer, (or portions thereof).

Preferably the heating elements can be stacked (on top of each other). Furthermore, the heating elements may be designed as a parallel hooked up (overall) resistance (which makes possible in particular a stacking one on top of another).

A diameter of the clearance between the first and the second heating element can be smaller than, equal to, or larger than a thickness of the first and/or second heating element.

In one specific embodiment, the polymer layer forms a PTC resistance.

The substrate—if provided—serves preferably as a heat exchanger.

Thanks to the polymer structure, particularly the polymer layer, on the whole a large (actively) heatable surface can be realized, so that the necessary surface temperature can be lowered for the same overall heating power and the same overall design space. At (maximum) surface temperatures of, for example, under 200° C., relatively high overall heating powers are still possible, nonetheless.

The (respective) substrate can be made at least for a portion, preferably entirely, of plastic, particularly a polymer such as polyether ketone and/or polyamide. Particularly preferred is a production from polyethylene (PE) and/or polypropylene (PP) and/or polyether ether ketone (PEEK) and/or (short) fibre-reinforced polyamide (such as PA-GF).

The substrate can be made from an electrically insulating material. By an electrically insulating material is meant in particular a material having an electrical conductivity at room temperature (25° C.) of less than 10-1 S·m−1 (optionally less than 10-8 S·m−1). Accordingly, by an electrical conductor or a material (or coating) with electrical conductivity is meant a material having an electrical conductivity of preferably at least 10 S·m−1, further preferably at least 103 S·m−1 (at room temperature of in particular 25° C.).

The polymer structure (possibly containing carbon), particularly the polymer layer, or the polymer structures (possibly containing carbon), particularly the polymer layers, and/or a corresponding paste for their preparation, may comprise at least one polymer (as an particularly crystalline binder), preferably based on at least one olefin; and/or at least one copolymer of at least one olefin and at least one monomer, which can be copolymerized therewith, e.g., ethylene/acrylic acid and/or ethylene/ethyl acrylate and/or ethylene/vinyl acetate; and/or at least one polyalkenamer (polyacetylene or polyalkenylene), such as polyoctenamer; and/or at least one, particularly melt-deformable fluoropolymer, such as polyvinylidene fluoride and/or copolymers thereof.

In general, the (respective) polymer structure, particularly the polymer layer, may have a continuous surface (without interruptions) or be structurized, for example, it may have gaps (perforations) or recesses.

A contour of the respective heating element (preferably several or all heating elements) may be polygonal, particularly tetragonal, preferably rectangular or oval, particularly elliptical, preferably (circular) round.

At least one clearance (possibly several or all clearances) may be bounded by (precisely) two or more heating elements.

A cross section of the clearance (generally, the fluid duct) may be polygonal, particularly tetragonal, preferably rectangular or oval, particularly elliptical, preferably (circular) round.

A cross section within a clearance (fluid duct) may vary or remain constant (over its length). Cross sections of various clearances or fluid ducts (i.e., clearances or fluid ducts not formed by the same pair or the same group of heating elements) may also differ from one another or be identical. For example, cross sections of the clearances or fluid ducts may be formed slot-like (particularly as rectangular slots).

Basically, the term “conductive” in regard to the conductive components of the heating appliance is to be understood as an abbreviation for “electrically conductive”.

The fluid heating appliance is preferably designed for an operation in the low-voltage range (e.g. ≤100 volts or ≤60 volts). Alternatively, the fluid heating appliance may be designed for the high-voltage range (e.g. >100 volts, preferably >400 volts, or more than 800 V).

The heating appliance may be designed for an operation with DC and/or AC voltage and/or PWM.

The substrate or the substrates may be designed as a plate, particularly a plastic plate, and/or have a thickness of at least 0.1 mm, preferably at least 0.5 mm, further preferably at least 1.0 mm and/or at most 5.0 mm, further preferably at most 3.0 mm. The respective thickness is in particular an average thickness or a thickness of the largest region with constant thickness.

A (layer) thickness of the respective polymer layer may be ≤1 mm, preferably ≤0.5 mm, even more preferably ≤0.2 mm.

The polymer layer (of at least one of the heating element, preferably of several or all of the heating elements) may be (at least on average) thinner than the corresponding substrate, for example by a factor of 1.1; further preferably by a factor of 1.5.

The (respective) polymer layer is preferably in contact with the (respective) substrate over at least 20%, further preferably at least 50%, even more preferably at least 80% of a surface of the substrate facing toward the polymer layer. In this way, heat can be effectively transferred via the substrate (which then serves as a further heat exchanger).

The (respective) polymer structure (polymer layer) and/or the (respective) substrate may be formed planar at least substantially. For a better heat transfer, elevations (depressions) may be provided. The proportion of the conductive component or the carbon fraction in the polymer layer of at least one heating element (preferably several or all heating elements) may be chosen such that it permits a current flow (e.g., in particulate form, with the particles correspondingly touching or being close together).

On the whole, the disclosure makes it possible to stack heating elements (particularly in electrical heating fins) with a defined spacing and to energize them, wherein the heating elements (fins) may have an end contour preferably with a chipless manufacturing process (such as a stamping and/or bending process) which can adjust and maintain a defined spacing when the heating elements (fins) are joined together and at the same time constitutes a contact surface for the electrode(s) of the respective heating element (the respective heating fin) as a current-conducting bridge. The heating elements (fins) may have different contours, such as an opening (threading) with a collar (possibly for stringing onto a (rod-shaped) carrier), wherein the collar serves preferably as a spacer between the heating elements (fins) or a rolling or flanging at one end of the heating element (the fin), which preferably defines by its diameter or its height a spacing between the heating elements (fins).

An electrical connection is preferably created by a contact surface between the aforementioned collar and a carrier or the aforementioned rolling or flanging and a (flat) bridge. An electrical connection can be made either by a form-fitting and/or force-locking manufacturing process (such as press fitting, soldering and/or welding). On the whole, a stacking of heating elements (heating fins) with defined spacing can be done in an economical manner. Optionally, a function integration can be achieved by a simultaneous electrical contacting of the heating elements (heating fins) on the spacer. In particular, additional parts for the spacer and/or an electrical connection of the heating elements to the bridge can be avoided.

Further embodiments will emerge from the dependent claims.

In the following, the disclosure will be described with the aid of exemplary embodiments, which are explained more closely with the aid of the enclosed figures. There are shown:

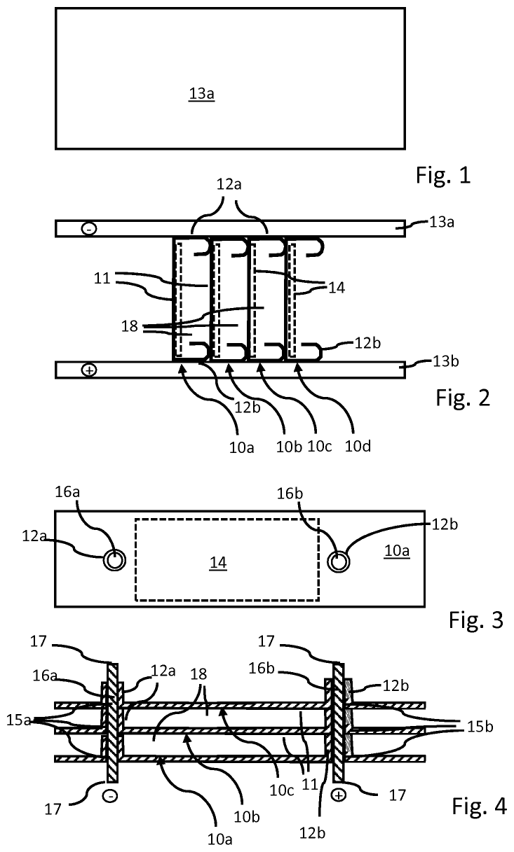

FIG. 1 a first embodiment of a heating appliance according to the disclosure in a view from above (schematically);

FIG. 2 the embodiment of FIG. 2 in a schematic view from the side;

FIG. 3 a further embodiment of the heating appliance according to the disclosure in a schematic view from above; and

FIG. 4 the embodiment of FIG. 3 in a schematic sectional representation.

In the following description, the same reference numbers are used for identical or equivalent parts.

FIGS. 1 and 2 show a first embodiment of the heating appliance according to the disclosure. The heating appliance comprises several (for example, four) heating elements 10a-10d. The heating elements are identical in construction in FIG. 2 (which need not be the case). Each of the heating elements 10a-10d comprises a (plate-shaped) main body 11 as well as (respectively) two (edge-side) spacers 12a, 12b. The spacers 12a, 12b are formed by a crimping (flanging) from the corresponding heating element (integrally) and define a spacing of the heating elements 10a-10d or their main body 11 relative to each other. The spacers 12a of the heating elements 10a-10d are in (mechanical and electrical) contact with a bridge element 13a, which can be formed of metal, for example (or some other conductive material). The bridge element 13a here is connected to a minus pole. Accordingly, the spacers 12b of the heating elements 10a-10d are connected to a bridge element 13b which in turn is connected to a plus pole. The bridge element 13b may be designed identical to the bridge element 13a.

The bridge elements 13a, 13b may be formed (respectively) as a plate and/or a strip and/or a moulding and/or a rod and/or a lattice.

The heating elements 10a-10d may be formed (respectively) of a conductive polymer structure or may comprise such a structure. In the latter case, the heating elements 10a-10d may (respectively) comprise a substrate (which might not be electrically conductive), on which a conductive polymer coating (shown stippled) is provided as the polymer structure 14. The respective polymer structure 14 per FIG. 2 is provided only on one side of the respective main body 11, but it may also be provided for example on both sides and/or (at least partly) on the spacers 12a and/or 12b.

FIGS. 3 and 4 show a further embodiment of the heating appliance according to the disclosure. Here as well, several (for example, three) heating elements 10a, 10b and 10c are provided (specifically preferably stacked on one another). Each of the heating elements 10a, 10b and 10c comprises two openings 15a, 15b, which are bordered by corresponding spacers 12a, 12b. The spacers 12a, 12b here are configured as a collar, defining a spacing from the next fin. Through the opening 15a there is led a bridge element 16a. Through the openings 12b there is led a bridge element 16b. The bridge elements 16a, 16b preferably contact (mechanically and electrically) the spacers 12a and 12b.

The bridge elements 16a, 16b may be associated with a fixation means (not shown), such as a screw nut or the like, at their (respective) ends 17, in order to hold together the stack of heating elements 10a, 10b and 10c. Optionally, a (respective) end of the bridge element 16a, 16b may also be provided with an enlargement, which holds the stack of heating elements 10a-10c together on one side of the stack. On the other side, for example, a (screw) nut can be screwed on to hold the said stack (together). Other holding devices are conceivable.

FIG. 3 shows schematically (stippling) a polymer coating as the polymer structure 14. The polymer coating may also extend over fewer or more (for example, respectively all) of the heating elements 10a, 10b and 10c (on one side or both sides). Here as well, the spacers 12a, 12b as such may optionally comprise (at least partially) a polymer structure or be built from such a structure. Basically, the heating elements 10a, 10b and 10c may also be built (entirely) from a conductive polymer structure (alternatively: comprise a substrate as well as a polymer structure placed on it, particularly a polymer coating).

Between the individual heating elements 10a-10d (according to the embodiment of FIG. 1 and 2) or 10a-10c (according to the embodiments of FIGS. 3 and 4) there are provided respective clearances 18, through which fluid can flow for its heating. The fluid may be a liquid or a gas, particularly water or air.

In this place, it should be pointed out that all of the above described parts are claimed as essential to the disclosure in themselves and in any combination, particularly the details represented in the drawings. Modifications of these parts are within the purview of the skilled person.

### REFERENCE NUMBERS

10a, 10b, 10c, 10d Heating element

11 Main body

12a Spacer

12b Spacer

13a Bridge element

13b Bridge element

14 Polymer structure

15a, 15b Opening

16a, 16b Bridge element

17 End

18 Clearance

1. Electric heating appliance for a motor vehicle, comprising a first heating element with a corresponding main body and at least one second heating element with a corresponding main body, wherein a clearance is formed between the heating elements through which fluid can flow for its heating, wherein the heating elements are joined together by at least one spacer arranged between them wherein the spacer is a fixed component of the first heating element.

2. Heating appliance according to claim 1, wherein the spacer is connected undetachably to the main body of the first heating element and/or it is connected by material bonding, force locking and/or form fitting to the main body of the first heating element and/or it is formed as a monolithically moulded-on component of the first heating element.

3. Heating appliance according to claim 1, wherein the heating elements each comprise a polymer structure, containing a polymer component and a conductive component and/or preferably comprise in each case a substrate and/or a polymer layer as the polymer structure.

4. Heating appliance according to claim 1,
wherein the first and/or second heating element are electrically contacted across the spacer.

5. Heating appliance according to claim 1
wherein the spacer is formed from the first heating element by cutting and/or stamping and/or bending.

6. Heating appliance according to claim 1
wherein the spacer is in electrical and/or mechanical contact with a carrier and/or bridge element which electrically and/or mechanically connects the first and the second heating element, wherein a connection between spacer and carrier and/or bridge element is provided by force locking and/or material bonding.

7. Heating appliance according to claim 1,
wherein the first heating element comprises at least one opening for receiving a carrier and/or bridge element wherein the at least one spacer is arranged at least partly around the opening.

8. Heating appliance according to claim 1
wherein the spacer is formed at an edge of the first heating element by a rolling and/or flanging.

9. Heating appliance according to claim 1,
wherein at least three heating elements are provided with corresponding clearances.

10. Method for producing an electric heating appliance according to claim 1, comprising a first heating element with a corresponding main body and at least one second heating element with a corresponding main body, wherein a clearance is formed between the heating elements through which fluid can flow for its heating, wherein at least one spacer is formed as a fixed component of the first heating element such that the spacer separates the first and the second heating element from each other.

11. Method according to claim 10,
wherein the spacer is connected undetachably to the main body of the first heating element and/or it is connected by material bonding, force locking and/or form fitting to the main body of the first heating element and/or it is formed as a monolithically moulded-on component of the first heating element.

12. Method according to claim 10,
wherein the heating elements each comprise a polymer structure, containing a polymer component and a conductive component, and/or comprise in each case a substrate and/or a polymer layer as the polymer structure.

13. Method according to claim 10,
wherein the spacer is formed from the first heating element by cutting and/or stamping and/or bending.

14. Method according to claim 10,
wherein the spacer is brought into electrical and/or mechanical contact with a carrier and/or bridge element which electrically and/or mechanically connects the first and the second heating element, wherein a connection between spacer and carrier and/or bridge element is provided by force locking and/or material bonding.

15. Method according to claim 10,
wherein the spacer is formed at an edge of the first heating element by a rolling and/or flanging.

16. Method for operating a heating appliance according to claim 1, wherein fluid, particularly air, or a liquid, such as water, flows through the at least one clearance and is thereby heated.

17. (canceled)

18. Electric heating appliance according to claim 1, wherein the at least one spacer is a conductive spacer.

19. Heating appliance according to claim 3 wherein the conductive component is a carbon component, and/or the substrate is an insulating substrate.

20. Heating appliance according to claim 6 wherein the connection between spacer and carrier and/or bridge element is provided by press-fitting and/or soldering and/or welding, particularly laser welding.

21. Heating appliance according to claim 7, wherein the carrier and/or bridge element is rod-shaped and conductive.
